(19) United States
(12) Patent Application Publication
(10) Pub. No.: US 2020/0216935 A1
(43) Pub. Date: Jul. 9, 2020

(54) HARD POWDER PARTICLES WITH IMPROVED COMPRESSIBILITY AND GREEN STRENGTH

(71) Applicant: TENNECO INC., Lake Forest, IL (US)

(72) Inventors: Philippe Beaulieu, Coventry (GB); Mathieu Boisvert, Waupun, WI (US); Denis B. Christopherson, JR., Waupun, WI (US)

(21) Appl. No.: 16/732,831

(22) Filed: Jan. 2, 2020

Related U.S. Application Data
(60) Provisional application No. 62/803,260, filed on Feb. 8, 2019.
(60) Provisional application No. 62/788,709, filed on Jan. 4, 2019.

(51) Int. Cl. C22C 30/02; B22F 9/08; B22F 1/00

(52) U.S. Cl. CPC C22C 30/02; B22F 2301/10; B22F 1/0085; B22F 9/082

(57) ABSTRACT

A powder metal material and sintered component formed of the powder metal material is provided. The powder metal material comprises a plurality of particles including copper in an amount of 10 wt. % to 50 wt. %, based on the total weight of the particles. The particles also include at least one of iron, nickel, an cobalt. The particles further include at least one of boron, carbon, chromium, manganese, molybdenum, nitrogen, niobium, phosphorous, sulfur, aluminum, bismuth, silicon, tin, tantalum, titanium, vanadium, tungsten, hafnium, and zirconium. The particles are formed by atomizing and optionally heat treating. The particles consist of a first area and a second area, wherein the first area is copper-rich and the second area includes hard phases. The hard phases being present in an amount of at least 33 wt. %, based on the total weight of the second area.

### CROSS-REFERENCE TO RELATED APPLICATIONS

This U.S. utility patent application claims priority to U.S. provisional patent application No. 62/788,709, filed Jan. 4, 2019, and U.S. provisional patent application No. 62/803,260, filed Feb. 8, 2019, the entire content of which are incorporated herein by reference.

### BACKGROUND

This invention relates generally to a powder metal material, a method of manufacturing the powder metal material, a sintered component formed of the powder metal material, and a method of manufacturing the sintered component.

### RELATED ART

Powder metal materials are oftentimes used to form components with improved wear resistance for automotive vehicle applications, such as but not limited to valve guides, valve seat inserts, and turbo charger bushings. Hard powder particles are sometimes included in powder mixes to improve the wear resistance of said components. The powder metal materials are typically in the form of particles formed by water or gas atomizing a melted metal material. The atomized particles could be subjected to various treatments, such as screening, milling, heat treatments, mixing with other powders, consolidated/pressing, and/or sintering to form the components with improved properties. It is generally the case that the more hard phases the powder particles contain, the more wear resistant the resulting sintered component formed of the powder particles will be. Therefore, increasing the amount of hard phases and/or the amount of hard particles that contain these hard phases in powder metal components is desirable, as it will increase their overall wear resistance. In general, hard particles have a Vickers microhardness typically larger than 500 HV.

Powder metal materials having good processability are also desired, as processability has a direct impact on cost and, ultimately, the feasibility of making a component. For example, powder mixes used to make components via the press and sintered process should be compressible, i.e. they should have the ability to reach a relatively high green density for a given applied pressure. Powder metal materials with high compressibility provide, among other things, parts with improved green strength and promote a higher sintered strength. It is generally the case that the more hard phases a powder particle contains, the lower is its compressibility. In practice, this limits the amount of hard particles that can be incorporated in a powder mixes, therefore capping the overall wear resistance of powder metal components.

### SUMMARY

One aspect of the invention provides a powder metal material with improved compressibility and improved green strength. The powder metal material comprises a plurality of particles including copper (Cu) in an amount of 10 wt. % to 50 wt. %, based on the total weight of the particles. The particles include at least one of iron (Fe), nickel (Ni), cobalt (Co); and the particles include at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr).

Another aspect of the invention provides a sintered powder metal material. The sintered powder metal material includes copper (Cu) in an amount of 10 wt. % to 50 wt. %, based on the total weight of the sintered powder metal material. The sintered powder metal material also includes at least one of iron (Fe), nickel (Ni), cobalt (Co); and said sintered powder metal material includes at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr).

Another aspect of the invention provides a method of manufacturing a powder metal material. The method comprises the steps of providing a melted alloy composition including copper pre-alloyed in the alloy composition, the copper being present in an amount of 10 wt. % to 50 wt. %, based on the total weight of the composition. The alloy composition further includes at least one of iron (Fe), nickel (Ni), cobalt (Co); and the alloy composition further includes at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr). The method also includes atomizing the melted alloy composition to atomized particles.

### BRIEF DESCRIPTION OF THE DRAWINGS

FIG. 1 includes a Table providing an overview of possible compositions of a powder metal material, including compositions of four preferred cases;

FIG. 2 includes a Table providing examples of hard powder particles chemical compositions, including two tool steel reference materials for comparison;

FIGS. 3-5 illustrate the microstructures of example powder metal materials;

FIG. 6 present the microstructure of a sintered powder metal material made with 100% of the powder presented in FIG. 3.

### DETAILS DESCRIPTION OF EXEMPLARY EMBODIMENTS

One aspect of the invention provides a powder metal material having a high compressibility and wear resistance, as well as good processability, and a method of manufacturing the powder metal material. Thus, the powder metal material can be used to form sintered components for automotive vehicle applications, such as valve guides, valve seat inserts, and turbo charger bushings.

The powder metal material contains two major constituents (i.e. microstructural areas), one rich in copper and the other one that provides the hard phases for the wear resistance. The constituent rich in copper is softer than the constituent with the hard phases and allows for the powder particles to be deformed during compaction, which provides the improved compressibility and green strength.

Oftentimes, powder mixes designed to make parts for wear resistance applications contain hard particles that provide the hard phases for wear resistance. However, hard particles have, by nature, a low compressibility which limits the amount of hard particles that can be included in a powder mix and is therefore a limit to the maximum wear resistance of the final part. The presence of a softer copper-rich constituent in the hard powder particles improves the compressibility of these hard particles and allows to increase the amount of hard particle in a powder mix. The presence of a softer copper-rich constituent on the surface of the powder particles also provides a means to increase green strength.

The copper-rich constituent is located inside the powder particles and also on the surface of the powder particles. This creates areas that can plastically deform more easily during compaction and creates stronger mechanical bonds between the particles which improve green strength. This is an important aspect for press and sintered parts as the green parts must hold their shape during their transfer from the press to the furnace. It is a known issue that low green strength parts can loose their shape before sintering. Therefore, low strength will cause an increased amount of defects, such as green chipping and/or high distortion leading to out of shape parts.

The powder metal material is formed by water or gas atomizing a melt, but other powder manufacturing processes could be used, for example plasma atomization and rotating disk atomization, to form a plurality of atomized particles, also referred to as the powder metal material. The method can also optionally includes heat treating the atomized particles and/or mechanical processes such as milling or grinding.

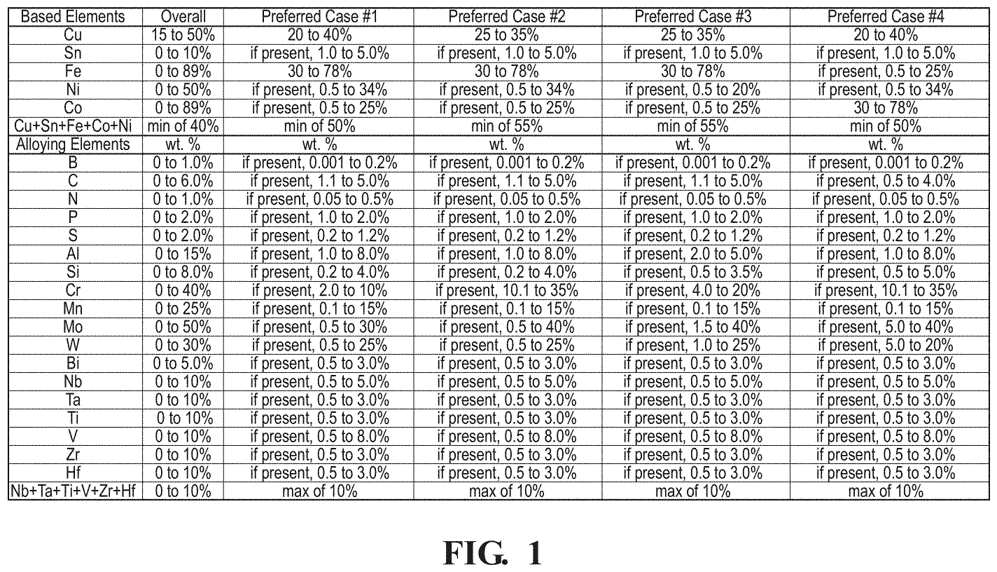

As indicated above, the powder metal material includes a plurality of particles formed by atomization, for example water or gas atomization. In general, the powder metal material includes copper an amount of 10 wt. % to 50 wt. % which has been pre-alloyed in a composition that also includes at least one of iron (Fe), nickel (Ni), cobalt (Co), and at least one other element of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr). An overview of possible compositions of the novel powder metal material is provided in the Table of FIG. 1.

As shown in the Table of FIG. 1 for the overall example composition, each element has a specific range of compositions that can be present in the novel powder metal materials. Copper (Cu) is between 15 wt. % and 50 wt. %, tin (Sn) is between 0 wt. % and 10 wt. %, iron (Fe) is between 0 wt. % and 89 wt. %, nickel (Ni) is between 0 wt. % and 50 wt. %, cobalt (Co) is between 0 wt. % and 89 wt. %, boron (B) is between 0 wt. % and 1.0 wt. %, carbon (C) is between 0 wt. % and 6.0 wt. %, nitrogen (N) is between 0 wt. % and 1.0 wt. %, phosphorus (P) is between 0 wt. % and 2.0 wt. %, sulfur (S) is between 0 wt. % and 2.0 wt. %, aluminum (Al) is between 0 wt. % and 15 wt. %, silicon (Si) is between 0 wt. % and 8.0 wt. %, chromium (Cr) is between 0 wt. % and 40 wt. %, manganese (Mn) is between 0 wt. % and 25 wt. %, molybdenum (Mo) is between 0 wt. % and 50 wt. %, tungsten (W) is between 0 wt. % and 30 wt. %, bismuth (Bi) is between 0 wt. % and 5 wt. %, niobium (Nb) is between 0 wt. % and 10 wt. %, tantalum (Ta) is between 0 wt. % and 10 wt. %, titanium (Ti) is between 0 wt. % and 10 wt. %, vanadium (V) is between 0 wt. % and 10 wt. %, zirconium (Zr) is between 0 wt. % and 10 wt. %, and hafnium (Hf) is between 0 wt. % and 10 wt. %, based on the total weight of the powder metal material.

FIG. 1 also presents some restrictions on the overall chemical composition the novel powder particles can have. For instance, the total amount of copper, tin, iron, nickel, and cobalt should be equal to or larger than 40 wt. %. In addition, the total amount of niobium, tantalum, titanium, vanadium, zirconium, and hafnium should be equal to or lower than 10 wt. % as these elements form compounds with high melting points that are difficult to dissolve at typical atomization temperatures (about 1300 to 2000° C.).

FIG. 1 also presents preferred ranges for the chemical composition of hard powder particles with improved compressibility and green strength. For the preferred composition #1, copper (Cu) is between 20 wt. % and 40 wt. %, iron (Fe) is between 30 wt. % and 78 wt. %, if tin (Sn) is present it is between 1.0 wt. % and 5.0 wt. %, if nickel (Ni) is present it is between 0.5 wt. % and 34 wt. %, if cobalt (Co) is present it is between 0.5 wt. % and 25 wt. %. The total amount of copper, tin, iron, nickel, and cobalt should be equal to or larger than 50 wt. %. At least one of the alloying elements listed is also present in the preferred composition #1. If boron (B) is present it is between 0.001 wt. % and 0.2 wt. %, if carbon (C) is present it is between 1.1 wt. % and 5.0 wt. %, if nitrogen (N) is present it is between 0.05 wt. % and 0.5 wt. %, if phosphorus (P) is present it is between 1.0 wt. % and 2.0 wt. %, if sulfur (S) is present it is between 0.2 wt. % and 1.2 wt. %, if aluminum (Al) is present it is between 1.0 wt. % and 8.0 wt. %, if silicon (Si) is present it is between 0.2 wt. % and 4.0 wt. %, if chromium (Cr) is present it is between 2.0 wt. % and 10 wt. %, if manganese (Mn) is present it is between 0.1 wt. % and 15 wt. %, if molybdenum (Mo) is present it is between 0.5 wt. % and 30 wt. %, if tungsten (W) is present it is between 0.5 wt. % and 25 wt. %, if bismuth (Bi) is present it is between 0.5 wt. % and 3.0 wt. %, if niobium (Nb) is present it is between 0.5 wt. % and 5.0 wt. %, if tantalum (Ta) is present it is between 0.5 wt. % and 3.0 wt. %, if titanium (Ti) is present it is between 0.5 wt. % and 3.0 wt. %, if vanadium (V) is present it is between 0.5 wt. % and 8 wt. %, if zirconium (Zr) is present it is between 0.5 wt. % and 3.0 wt. %, and if hafnium (Hf) is present it is between 0.5 wt. % and 3.0 wt. %, based on the total weight of the powder metal material. The total amount of niobium, tantalum, titanium, vanadium, zirconium, and hafnium should be equal to or lower than 10 wt. %.

For the preferred composition #2 presented in FIG. 1, copper (Cu) is between 25 wt. % and 35 wt. %, iron (Fe) is between 30 wt. % and 78 wt. %, if tin (Sn) is present it is between 1.0 wt. % and 5.0 wt. %, if nickel (Ni) is present it is between 0.5 wt. % and 34 wt. %, if cobalt (Co) is present it is between 0.5 wt. % and 25 wt. %. The total amount of copper, tin, iron, nickel, and cobalt should be equal to or larger than 55 wt. %. At least one of the alloying elements listed is also present in preferred composition #2. If boron (B) is present it is between 0.001 wt. % and 0.2 wt. %, if carbon (C) is present it is between 1.1 wt. % and 5.0 wt. %, if nitrogen (N) is present it is between 0.05 wt. % and 0.5 wt. %, if phosphorus (P) is present it is between 1.0 wt. % and 2.0 wt. %, if sulfur (S) is present it is between 0.2 wt. % and 1.2 wt. %, if aluminum (Al) is present it is between 1.0 wt. % and 8.0 wt. %, if silicon (Si) is present it is between 0.2 wt. % and 4.0 wt. %, if chromium (Cr) is present it is between 10.1 wt. % and 35 wt. %, if manganese (Mn) is present it is between 0.1 wt. % and 15 wt. %, if molybdenum (Mo) is present it is between 0.5 wt. % and 40 wt. %, if tungsten (W) is present it is between 0.5 wt. % and 25 wt. %, if bismuth (Bi) is present it is between 0.5 wt. % and 3.0 wt. %, if niobium (Nb) is present it is between 0.5 wt. % and 5.0 wt. %, if tantalum (Ta) is present it is between 0.5 wt. % and 3.0 wt. %, if titanium (Ti) is present it is between 0.5 wt. % and 3.0 wt. %, if vanadium (V) is present it is between 0.5 wt. % and 8 wt. %, if zirconium (Zr) is present it is between 0.5 wt. % and 3.0 wt. %, and if hafnium (Hf) is present it is between 0.5 wt. % and 3.0 wt. %, based on the total weight of the powder metal material. The total amount of niobium, tantalum, titanium, vanadium, zirconium, and hafnium should be equal to or lower than 10 wt. %.

For the preferred composition #3 presented in FIG. 1, copper (Cu) is between 25 wt. % and 35 wt. %, iron (Fe) is between 30 wt. % and 78 wt. %, if tin (Sn) is present it is between 1.0 wt. % and 5.0 wt. %, if nickel (Ni) is present it is between 0.5 wt. % and 20 wt. %, if cobalt (Co) is present it is between 0.5 wt. % and 25 wt. %. The total amount of copper, tin, iron, nickel, and cobalt should be equal to or larger than 55 wt. %. At least one of the alloying elements listed is also present in the preferred composition #3. If boron (B) is present it is between 0.001 wt. % and 0.2 wt. %, if carbon (C) is present it is between 1.1 wt. % and 5.0 wt. %, if nitrogen (N) is present it is between 0.05 wt. % and 0.5 wt. %, if phosphorus (P) is present it is between 1.0 wt. % and 2.0 wt. %, if sulfur (S) is present it is between 0.2 wt. % and 1.2 wt. %, if aluminum (Al) is present it is between 2.0 wt. % and 5.0 wt. %, if silicon (Si) is present it is between 0.5 wt. % and 3.5 wt. %, if chromium (Cr) is present it is between 4.0 wt. % and 20 wt. %, if manganese (Mn) is present it is between 0.1 wt. % and 15 wt. %, if molybdenum (Mo) is present it is between 1.5 wt. % and 40 wt. %, if tungsten (W) is present it is between 1.0 wt. % and 25 wt. %, if bismuth (Bi) is present it is between 0.5 wt. % and 3.0 wt. %, if niobium (Nb) is present it is between 0.5 wt. % and 5.0 wt. %, if tantalum (Ta) is present it is between 0.5 wt. % and 3.0 wt. %, if titanium (Ti) is present it is between 0.5 wt. % and 3.0 wt. %, if vanadium (V) is present it is between 0.5 wt. % and 8 wt. %, if zirconium (Zr) is present it is between 0.5 wt. % and 3.0 wt. %, and if hafnium (Hf) is present it is between 0.5 wt. % and 3.0 wt. %, based on the total weight of the powder metal material. The total amount of niobium, tantalum, titanium, vanadium, zirconium, and hafnium should be equal to or lower than 10 wt. %.

For the preferred composition #4 presented in FIG. 1, copper (Cu) is between 20 wt. % and 40 wt. %, cobalt (Co) is present it is between 30 wt. % and 78 wt. %, if iron (Fe) is present it is between 0.5 wt. % and 25 wt. %, if tin (Sn) is present it is between 1.0 wt. % and 5.0 wt. %, if nickel (Ni) is present it is between 0.5 wt. % and 34 wt. %. The total amount of copper, tin, iron, nickel, and cobalt should be equal to or larger than 50 wt. %. At least one of the alloying elements listed is also present in preferred composition #4. If boron (B) is present it is between 0.001 wt. % and 0.2 wt. %, if carbon (C) is present it is between 0.5 wt. % and 4.0 wt. %, if nitrogen (N) is present it is between 0.05 wt. % and 0.5 wt. %, if phosphorus (P) is present it is between 1.0 wt. % and 2.0 wt. %, if sulfur (S) is present it is between 0.2 wt. % and 1.2 wt. %, if aluminum (Al) is present it is between 1.0 wt. % and 8.0 wt. %, if silicon (Si) is present it is between 0.5 wt. % and 5.0 wt. %, if chromium (Cr) is present it is between 10.1 wt. % and 35 wt. %, if manganese (Mn) is present it is between 0.1 wt. % and 15 wt. %, if molybdenum (Mo) is present it is between 5.0 wt. % and 40 wt. %, if tungsten (W) is present it is between 5.0 wt. % and 20 wt. %, if bismuth (Bi) is present it is between 0.5 wt. % and 3.0 wt. %, if niobium (Nb) is present it is between 0.5 wt. % and 5.0 wt. %, if tantalum (Ta) is present it is between 0.5 wt. % and 3.0 wt. %, if titanium (Ti) is present it is between 0.5 wt. % and 3.0 wt. %, if vanadium (V) is present it is between 0.5 wt. % and 8 wt. %, if zirconium (Zr) is present it is between 0.5 wt. % and 3.0 wt. %, and if hafnium (Hf) is present it is between 0.5 wt. % and 3.0 wt. %, based on the total weight of the powder metal material. The total amount of niobium, tantalum, titanium, vanadium, zirconium, and hafnium should be equal to or lower than 10 wt. %.

To provide the improved compressibility and/or green strength, the copper in the powder metal material is present in an amount such that copper-rich areas are present in the microstructure and/or on the surface of the powder particles. In other words, copper is not completely in solid solution. The amount of copper needed to form the copper-rich areas in the powder metal material is partly dependent on the presence of other alloying elements and on the cooling rate achieve during the atomization. For example, the cooling rate experienced during water atomization is larger than that experienced during gas atomization, which could lead to a larger amount of copper in solid solution compared to a gas atomized powder with the same chemical composition. Different approaches can be used to promote the formation of a larger fraction of copper-rich areas. For example, the amount of alloyed copper in the alloy composition could be increased. Alternatively, the atomized powders could be subjected to a heat treatment to induce precipitation of copper-rich areas in the powder particles and/or on their surfaces.

The powder metal materials have a high hardness due to the large amount of hard phases in the microstructure of the powder metal materials. Examples of hard phases that could be present in the particles include, but not limited to, borides (FeB, TiB₂), nitrides (Fe₂N, Fe₃N, TiN), carbides (Fe₃C, Cr₂₃C₆, (Cr,Fe)₂₃C₆, MoC, Mo₂C, TiC, Cr₇C₃, ZrC), carbonitrides (VNC, TiCN), phosphides (Fe₂P, Fe₃P, (Ni,Fe)₃P), silicides (WSi₂, Nb₅Si₃, (Mo,Co)Si₂), and other intermetallics such as FeMo, CoTi, and NiMo. These hard phases can be stoichiometric or non-stoichiometric and can be formed directly during the atomization and/or during subsequent treatments such as, but not limited to, a heat treatment and/or a mechanical treatment.

The powder metal material, which is the form of particles, should contain a high amount of hard phases to provide the desired wear resistance in the final power metal components and should also contain a copper-rich constituent to provide the improved compressibility and/or green strength. The amount of hard phases in the non copper-rich phase of the powder metal material should be high enough to provide a sufficient level of wear resistance. The amount of hard phases required to reach a certain wear resistance is dependent on many variables including the application and the chemistry of the hard phases in the powder metal material. For instance, iron carbides (ex: Fe₃C, (Fe,Cr)₃C) are not as hard as other types of carbides such as chromium carbides (Cr₇C₃) or tungsten carbides (WC) and the overall wear resistance of a component that contains softer carbides would be expected to be lower than a component that contains the same amount of harder carbides.

The powder metal material of the present invention can be referred to as hard particles. Hard particles, by definition, should contain a large fraction of hard phases to provide the desired wear resistance. Other types of alloys also contain hard phases, tool steels for instance typically contain less than 30 wt. % of various types of carbides (i.e. the hard phases). However, even if tool steels are considered hard alloys, they do not contain enough hard phases to be considered hard particles. Therefore, by definition, hard particles have a larger amount of hard phases than tool steels. The novel hard powder particles disclosed in this invention are made of two different major constituents (i.e. microstructural areas), one rich in copper that provides the improved compressibility and improved green strength and the other one that provides the hard phases for the wear resistance. The constituent that provides the wear resistance of the novel powder particles should contain at least 33 wt. % of the hard phases.

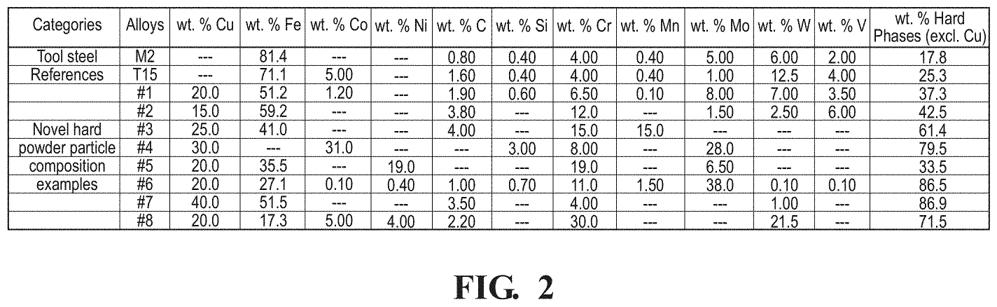

The amount and nature of the hard phases can vary depending on the conditions of the powder metal material. In other words, the state of the material, i.e. either as-atomized (this is also dependent on the type of atomization, ex: water or gas atomized) or heat treated (also dependent on the time and temperature used during the heat treatment) will change the amount and the nature of the hard phases in the hard powder metal material. One technique used to compare the amount and nature of the hard phases in various materials is to calculate the thermodynamical equilibrium of a chemical system as this provides the most stable state of that chemical system. There can however be slight variations in the amount and nature of the calculated phases that depend on the software and databases used and also the temperatures of the calculations. FIG. 2 presents a Table with examples novel hard particle chemical compositions, including two tool steel compositions for comparison. The total amount of hard phases (in wt. %) in each alloy was calculated with the FactSage software version 7.2 using the FSstel, SpMCBN, and FactPS databases. The selected temperature for the calculations was 600° C. as this is an average temperature used for the heat treatment of hard metallic alloys. Since only the non copper-rich phase contains the hard phases, the concentration of hard phases in each alloy was then calculated by excluding the copper-rich constituent.

The eight powder metal material examples presented FIG. 2 each provide particles containing a wt. % of hard phases in the non copper-rich constituent larger than 33 wt. %. The equilibrium thermodynamical calculations performed in the conditions described above provide the following results. Alloy #1 is a ferrous material pre-alloyed with copper with a large amount of various carbides, the majority of which are of the M₂₃C₆ stoichiometry. Alloy #2 is also a ferrous material pre-alloyed with copper, but with a larger carbon and chromium content compared to alloy #1. Alloy #2 contains different carbides as the hard phases, the majority of these being of the M₇C₃ and MC stoichiometry. Alloy #3 is also a ferrous material pre-alloyed with copper which is rich in chromium, manganese and carbon. The large amount of the hard phase are mostly made of carbides with the M₇C₃ stoichiometry. Alloy #4 is close to a Tribaloy® T-400 but pre-alloyed with 30 wt. % copper. The majority of the hard phases in alloy #4 are silicides. Alloy #5 is a ferrous alloy pre-alloyed with copper that is rich in nickel and chromium. The majority of the hard phases in alloy #5 are intermetallics of Cr—Fe—Mo. Alloy #6 is a molybdenum-rich alloy pre-alloyed with copper in which the majority of the hard phases are present as carbides that have a M₆C stoichiometry. Alloy #7 is a cast iron material pre-alloyed with copper in which the majority of the hard phases are present as cementite alloyed with chromium. Alloy #8 is a chromium and tungsten rich material pre-alloyed with copper which contains a large fraction of hard phases, the majority of which are carbides of the M₂₃C₆ stoichiometry. By comparison, the calculations for the tool steels M2 and T15 showed that the hard phases in both these tool steel are mainly carbides of the M₆C stoichiometry and that the amount of hard phases in the non copper-rich phase in the M2 and T15 tool steels is 17.8 wt. % and 25.3 wt. % respectively, i.e. lower than the 33 wt. % limit for the definition of a hard particle.

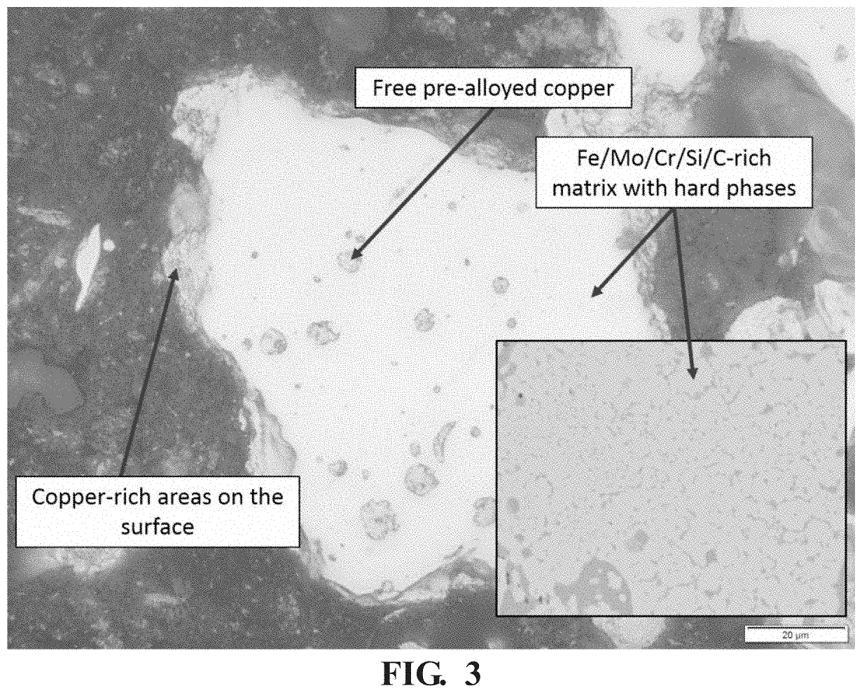

FIG. 3 presents an example embodiment of hard powder particles with improved compressibility and green strength having a copper content of 15 to 30 wt. % Cu. In this case, the copper content was measured to be 21 wt. %. The particles also contain Fe, Mo, Cr, Si and C. More specifically, the particles include about 20 to 30 wt. % Fe, 30 to 40 wt. % Mo, 10 to 20 wt. % Cr, 0.5 to 3 wt. % Si, and 0.5 to 2.0% C. The zoomed window in FIG. 3 present an SEM image that shows the large amount of hard phases in the structure of the matrix. The amount of hard phases in the Fe/Mo/Cr/Si/C-rich matrix is larger than 50 wt. %.

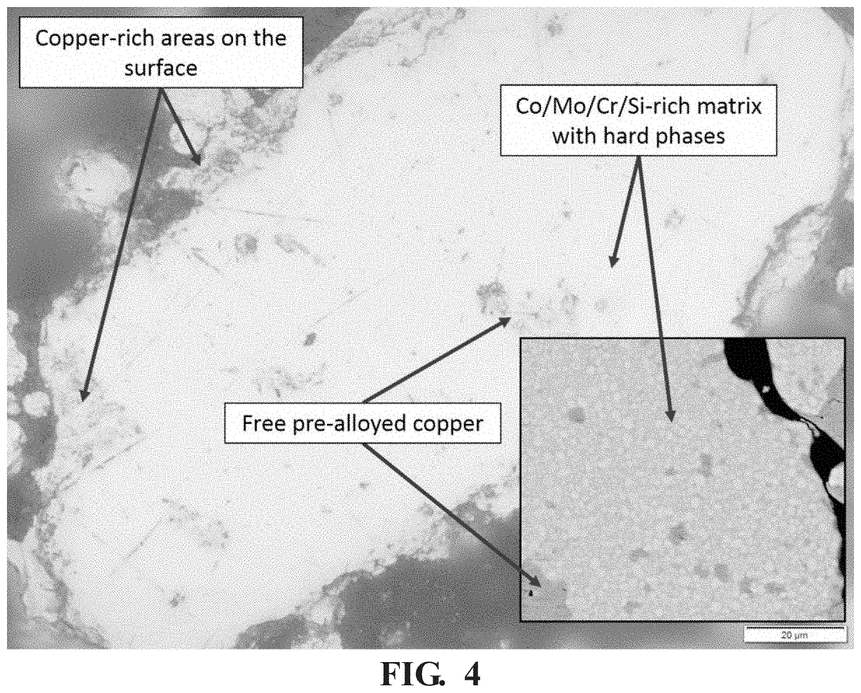

FIG. 4 presents an example embodiment of hard powder particles with improved compressibility and green strength having a copper content of about 20 to 40 wt. %. In this case, the copper content was measured to be 30 wt. %. The particles also contain Co, Mo, Cr, and Si. More specifically, the particles include 20 to 40 wt. % Co, 20 to 40 wt. % Mo, 5 to 15 wt. % Cr, and 2 to 6 wt. % Si. The zoomed window in FIG. 4 present an SEM image that shows the large amount of hard phases in the structure of the matrix. The amount of hard phases in the Co/Mo/Cr/Si-rich matrix is larger than 50 wt. %.

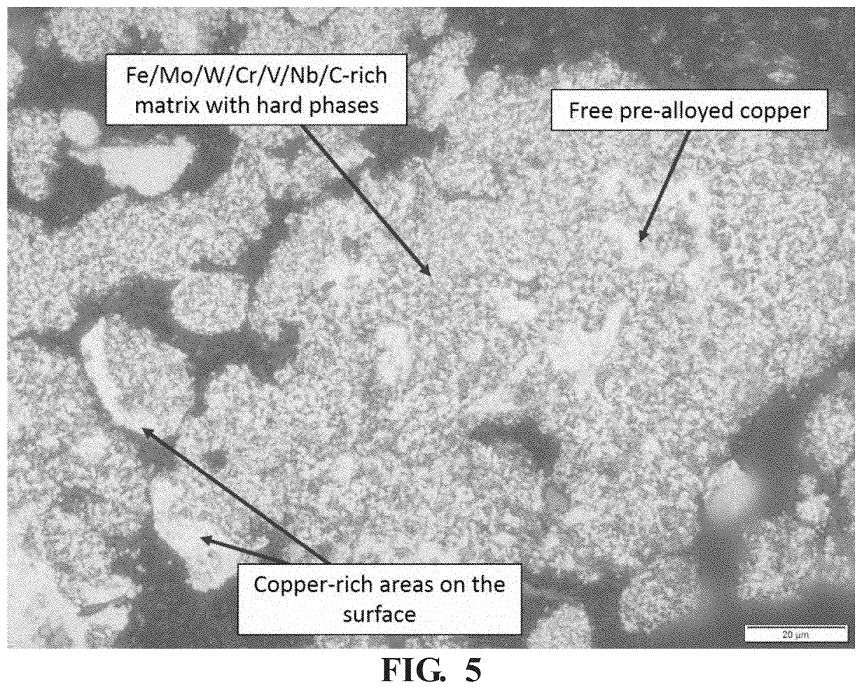

FIG. 5 presents an example embodiment of hard powder particles with improved compressibility and green strength having a copper content of about 20 to 40 wt. %. In this case, the copper content was measured to be 27 wt. %. The particles also contain Fe, Mo, W, Cr, V, Nb, and C. More specifically, the particles include about 40 to 60 wt. % Fe, 5 to 12 wt. % Mo, 4 to 10 wt. % Cr, 5 to 12 wt. % W, 2 to 7 wt. % V, 0.5 to 5 wt. % Nb and 1 to 3 wt. % C. The amount of hard phases in the Fe/Mo/W/Cr/V/Nb/C-rich matrix is larger than 40 wt. %.

Another aspect of the invention provides a sintered component formed of the powder metal material, and a method of making a component by pressing and sintering the powder metal material. The copper-rich phase of the powder metal material also provides advantages when the powder metal material is formed into the sintered component, for example good mechanical properties, such as strength.

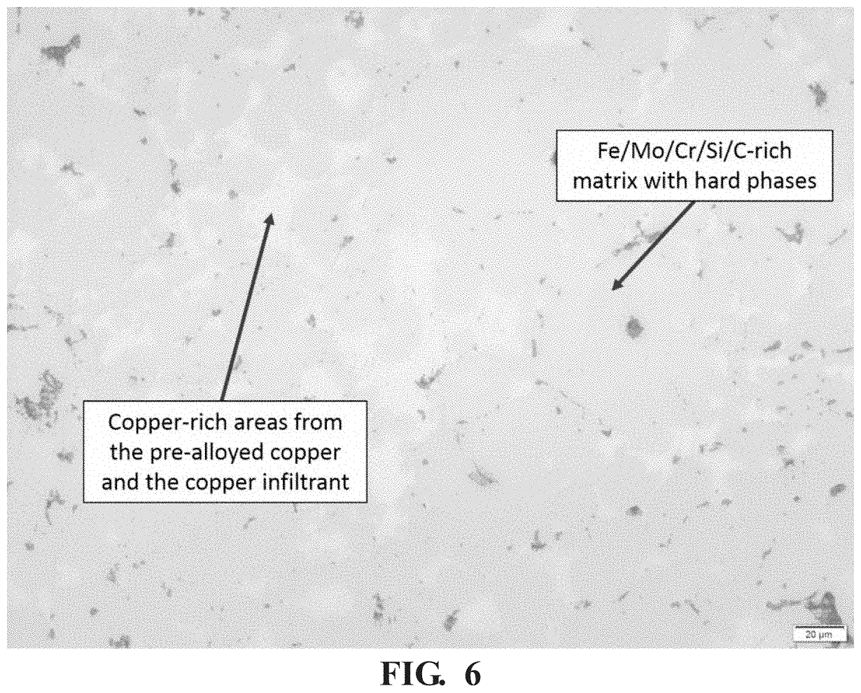

FIG. 6 presents an example embodiment of a sintered part made with 100% of the novel hard powder metal material disclosed in FIG. 3. The part was compacted using standard tooling and standard compaction pressure typically used in the industry. The green strength was high enough so the parts was able to be handled from the compacting press to the sintering furnace as any other green parts would. Evaluation of the compressibility and axial green strength was carried out with a PTC (“Powder Testing Center”). The mix made of 100% of the powder presented in FIG. 3 when pressed at 900 MPa showed a green density improvement larger than 8% and an axial green strength of 140 MPa, an improvement larger than 250% compared to the same alloy atomized without pre-alloyed copper.

The powder presented in FIG. 4 was also evaluated for axial green strength using the PTC (“Powder Testing Center”). A mix made of 100% of the powder presented in FIG. 4 provided a axial green strength of 149 MPa, which is a significant improvement compared to the same alloy but atomized without pre-alloyed copper. This improvement could not be quantified as the mix made of 100% of the powder without pre-alloyed copper had a green strength too low to be measured. For comparison, it is generally the case that a maximum of 30 to 40 wt. % of hard particles can be included in a powder mix to retain a green strength high enough for the part to be handled without breaking the parts.

The copper-rich phase leads to an improvement of several properties, including green strength, compressibility, diffusion of the elements during sintering, and bonding of the particles of the powder metal material. An axial green strength of 100 MPa is defined as the ultimate lower limit for green strength.

In addition to the significant improvement of the properties of the powder metal material discussed above, the high pre-alloyed copper content is also beneficial to improve thermal conductivity of the powder metal material and sintered component formed from the novel powder metal materials as copper and copper alloys have high thermal conductivities. For example, the powder metal material can be used to form valve seat inserts, valve guides, and turbo charger bushings which can be exposed to a high temperature (up to around 1000° C.) and the good thermal conductivity is generally favored for those types of components. The copper-rich phase of the powder metal material is also advantageous for other high temperature wear resistant and high performance applications.

The novel powder metal materials disclosed in this invention can also be used in other powder metal processes that are different from the press and sinter process. For instance, the novel powder metal materials can be used in a thermal spray process to produce a wear resistant layer deposit with improved thermal conductivity from the presence of a large amount of prealloyed copper. Additive manufacturing to create parts with improve thermal conductivities is another process in which these novel powders could be used.

Obviously, many modifications and variations of the present invention are possible in light of the above teachings and may be practiced otherwise than as specifically described while within the scope of the following claims. It is contemplated that all features described and of all embodiments can be combined with each other, so long as such combinations would not contradict one another.

What is claimed is:

1. A powder metal material, comprising:
a plurality of particles including copper (Cu) in an amount of 10 wt. % to 50 wt. %, based on the total weight of the particles;
said particles including at least one of iron (Fe), nickel (Ni), cobalt (Co); and
said particles including at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr).

2. The powder metal material of claim 1, wherein the copper (Cu) is present in an amount of 15 wt. % to 50 wt. %, tin (Sn) is in an amount of 0 wt. % to 10 wt. %, iron (Fe) is in an amount of 0 wt. % to 89 wt. %, nickel (Ni) is in an amount of 0 wt. % to 50 wt. %, cobalt (Co) is in an amount of 0 wt. % to 89 wt. %, boron (B) is in an amount of 0 wt. % to 1.0 wt. %, carbon (C) is in an amount of 0 wt. % to 6.0 wt. %, nitrogen (N) is in an amount of 0 wt. % to 1.0 wt. %, phosphorus (P) is in an amount of 0 wt. % to 2.0 wt. %, sulfur (S) is in an amount of 0 wt. % to 2.0 wt. %, aluminum (Al) is in an amount of 0 wt. % to 15 wt. %, silicon (Si) is in an amount of 0 wt. % to 8.0 wt. %, chromium (Cr) is in an amount of 0 wt. % to 40 wt. %, manganese (Mn) is in an amount of 0 wt. % to 25 wt. %, molybdenum (Mo) is in an amount of 0 wt. % to 50 wt. %, tungsten (W) is in an amount of 0 wt. % to 30 wt. %, bismuth (Bi) is in an amount of 0 wt. % to 5 wt. %, niobium (Nb) is in an amount of 0 wt. % to 10 wt. %, tantalum (Ta) is in an amount of 0 wt. % to 10 wt. %, titanium (Ti) is in an amount of 0 wt. % to 10 wt. %, vanadium (V) is in an amount of 0 wt. % to 10 wt. %, zirconium (Zr) is in an amount of 0 wt. % to 10 wt. %, and hafnium (Hf) is in an amount of 0 wt. % to 10 wt. %, based on the total weight of the particles.

3. The powder metal material of claim 1, wherein said particles consist essentially of said copper (Cu); said at least one of iron (Fe), nickel (Ni), cobalt (Co); and said at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr).

4. The powder metal material of claim 1, wherein the total amount of copper (Cu), tin (Sn), iron (Fe), nickel (Ni), and cobalt (Co) is at least 40 wt. %, based on the total weight of the particles.

5. The powder metal material of claim 1, wherein the total amount of niobium (Nb), tantalum (Ta), titanium (Ti), vanadium (V), zirconium (Zr), and hafnium (Hf) is not greater than 10 wt. %, based on the total weight of the particles.

6. The powder metal material of claim 1, wherein the copper (Cu) is present in an amount of 20 wt. % to 40 wt. %, based on the total weight of the particles; the iron (Fe) is present in an amount of 30 wt. % and 78 wt. %%, based on the total weight of the particles; the total amount of iron (Fe), copper (Cu), tin (Sn), nickel (Ni), and cobalt (Co) is at least 50 wt. %, based on the total weight of the particles; and the particles include at least one of boron (B), carbon (C), nitrogen (N), phosphorus (P), sulfur (S), aluminum (Al), silicon (Si), chromium (Cr), manganese (Mn), molybdenum (Mo), tungsten (W), bismuth (Bi), niobium (Nb), tantalum (Ta), titanium (Ti), vanadium (V), zirconium (Zr), and hafnium (Hf); and the total amount of niobium (Nb), tantalum (Ta), titanium (Ti), vanadium (V), zirconium (Zr), and hafnium (Hf) is not greater than 10 wt. %, based on the total weight of the particles.

7. The powder metal material of claim 6, wherein the boron (B), if present, is in an amount of 0.001 wt. % to 0.2 wt. %, based on the total weight of the particles; the carbon (C), if present, is in an amount of 1.1 wt. % to 5.0 wt. %, based on the total weight of the particles; the nitrogen (N), if present, is in an amount of 0.05 wt. % to 0.5 wt. %, based on the total weight of the particles; the phosphorus (P), if present, is in an amount of 1.0 wt. % to 2.0 wt. %, based on the total weight of the particles; the sulfur (S), if present, is in an amount of 0.2 wt. % to 1.2 wt. %, based on the total weight of the particles; the aluminum (Al), if present, is in an amount of 1.0 wt. % to 8.0 wt. %, based on the total weight of the particles; the silicon (Si), if present, is in an amount of is 0.2 wt. % to 4.0 wt. %, based on the total weight of the particles; the chromium (Cr), if present, is in an amount of 2.0 wt. % to 10 wt. %, based on the total weight of the particles; the manganese (Mn), if present, is in an amount of 0.1 wt. % to 15 wt. %, based on the total weight of the particles; the molybdenum (Mo), if present, is in an amount of 0.5 wt. % to 30 wt. %, based on the total weight of the particles; the tungsten (W), if present, is in an amount of 0.5 wt. % to 25 wt. %, based on the total weight of the particles; the bismuth (Bi), if present, is in an amount of 0.5 wt. % to 3.0 wt. %, based on the total weight of the particles; the niobium (Nb) if present, is in an amount of 0.5 wt. % to 5.0 wt. %, based on the total weight of the particles; the tantalum (Ta), if present, is in an amount of 0.5 wt. % to 3.0 wt. %, based on the total weight of the particles; the titanium (Ti), if present, is in an amount of 0.5 wt. % to 3.0 wt. %, based on the total weight of the particles; the vanadium (V), if present, is in an amount of 0.5 wt. % to 8 wt. %, based on the total weight of the particles; the zirconium (Zr), if present, is in an amount of 0.5 wt. % to 3.0 wt. %, based on the total weight of the particles; the hafnium (Hf), if present, is in an amount of 0.5 wt. % to 3.0 wt. %, based on the total weight of the particles; and the total amount of niobium (Nb), tantalum (Ta), titanium (Ti), vanadium (V), zirconium (Zr), and hafnium (Hf) is not greater than 10 wt. %, based on the total weight of the particles.

8. The powder metal material of claim 6, wherein the particles further include at least one of tin (Sn), nickel (Ni), and cobalt (Co); the tin (Sn), if present, is in an amount of 1.0 wt. % to 5.0 wt. %, based on the total weight of the particles; the nickel (Ni), if present, is in an amount of 0.5 wt. % and 34 wt. %, based on the total weight of the particles; and the cobalt (Co), if present, is in an amount of 0.5 wt. % and 25 wt. %, based on the total weight of the particles.

9. The powder metal material of claim 1, wherein the copper (Cu) is present in an amount of 25 wt. % to 35 wt. %, based on the total weight of the particles; the iron (Fe) is present in an amount of 30 wt. % and 78 wt. %, based on the total weight of the particles; the total amount of iron (Fe), copper (Cu), tin (Sn), nickel (Ni), and cobalt (Co) is at least 55 wt. %, based on the total weight of the particles; and the particles include at least one of boron (B), carbon (C), nitrogen (N), phosphorus (P), sulfur (S), aluminum (Al), silicon (Si), chromium (Cr), manganese (Mn), molybdenum (Mo), tungsten (W), bismuth (Bi), niobium (Nb), tantalum (Ta), titanium (Ti), vanadium (V), zirconium (Zr), and hafnium (Hf); and the total amount of niobium (Nb), tantalum (Ta), titanium (Ti), vanadium (V), zirconium (Zr), and hafnium (Hf) is not greater than 10 wt. %, based on the total weight of the particles.

10. The powder metal material of claim 9, wherein the boron (B), if present, is in an amount of 0.001 wt. % to 0.2 wt. %, based on the total weight of the particles; the carbon (C), if present, is in an amount of 1.1 wt. % to 5.0 wt. %, based on the total weight of the particles; the nitrogen (N), if present, is in an amount of 0.05 wt. % to 0.5 wt. %, based on the total weight of the particles; the phosphorus (P), if present, is in an amount of 1.0 wt. % to 2.0 wt. %, based on the total weight of the particles; the sulfur (S), if present, is in an amount of 0.2 wt. % to 1.2 wt. %, based on the total weight of the particles; the aluminum (Al), if present, is in an amount of 1.0 wt. % to 8.0 wt. %, based on the total weight of the particles; the silicon (Si), if present, is in an amount of is 0.2 wt. % to 4.0 wt. %, based on the total weight of the particles; the chromium (Cr), if present, is in an amount of 10.1 wt. % to 35 wt. %, based on the total weight of the particles; the manganese (Mn), if present, is in an amount of 0.1 wt. % to 15 wt. %, based on the total weight of the particles; the molybdenum (Mo), if present, is in an amount of 0.5 wt. % to 40 wt. %, based on the total weight of the particles; the tungsten (W), if present, is in an amount of 0.5 wt. % to 25 wt. %, based on the total weight of the particles; the bismuth (Bi), if present, is in an amount of 0.5 wt. % to 3.0 wt. %, based on the total weight of the particles; the niobium (Nb) if present, is in an amount of 0.5 wt. % to 5.0 wt. %, based on the total weight of the particles; the tantalum (Ta), if present, is in an amount of 0.5 wt. % to 3.0 wt. %, based on the total weight of the particles; the titanium (Ti), if present, is in an amount of 0.5 wt. % to 3.0 wt. %, based on the total weight of the particles; the vanadium (V), if present, is in an amount of 0.5 wt. % to 8 wt. %, based on the total weight of the particles; the zirconium (Zr), if present, is in an amount of 0.5 wt. % to 3.0 wt. %, based on the total weight of the particles; the hafnium (Hf), if present, is in an amount of 0.5 wt. % to 3.0 wt. %, based on the total weight of the particles; and the total amount of niobium (Nb), tantalum (Ta), titanium (Ti), vanadium (V), zirconium (Zr), and hafnium (Hf) is not greater than 10 wt. %, based on the total weight of the particles.

11. The powder metal material of claim 9, wherein the particles further include at least one of tin (Sn), nickel (Ni), and cobalt (Co); the tin (Sn), if present, is in an amount of 1.0 wt. % to 5.0 wt. %, based on the total weight of the particles; the nickel (Ni), if present, is in an amount of 0.5 wt. % and 34 wt. %, based on the total weight of the particles; and the cobalt (Co), if present, is in an amount of 0.5 wt. % and 25 wt. %, based on the total weight of the particles.

12. The powder metal material of claim 1, wherein the copper (Cu) is present in an amount of 25 wt. % to 35 wt. %, based on the total weight of the particles; the iron (Fe) is present in an amount of 30 wt. % and 78 wt. %, based on the total weight of the particles; the total amount of iron (Fe), copper (Cu), tin (Sn), nickel (Ni), and cobalt (Co) is at least 55 wt. %, based on the total weight of the particles; and the particles include at least one of boron (B), carbon (C), nitrogen (N), phosphorus (P), sulfur (S), aluminum (Al), silicon (Si), chromium (Cr), manganese (Mn), molybdenum (Mo), tungsten (W), bismuth (Bi), niobium (Nb), tantalum (Ta), titanium (Ti), vanadium (V), zirconium (Zr), and hafnium (Hf); and the total amount of niobium (Nb), tantalum (Ta), titanium (Ti), vanadium (V), zirconium (Zr), and hafnium (Hf) is not greater than 10 wt. %, based on the total weight of the particles.

13. The powder metal material of claim 12, wherein the boron (B), if present, is in an amount of 0.001 wt. % to 0.2 wt. %, based on the total weight of the particles; the carbon (C), if present, is in an amount of 1.1 wt. % to 5.0 wt. %, based on the total weight of the particles; the nitrogen (N), if present, is in an amount of 0.05 wt. % to 0.5 wt. %, based on the total weight of the particles; the phosphorus (P), if present, is in an amount of 1.0 wt. % to 2.0 wt. %, based on the total weight of the particles; the sulfur (S), if present, is in an amount of 0.2 wt. % to 1.2 wt. %, based on the total weight of the particles; the aluminum (Al), if present, is in an amount of 2.0 wt. % to 5.0 wt. %, based on the total weight of the particles; the silicon (Si), if present, is in an amount of is 0.5 wt. % to 3.5 wt. %, based on the total weight of the particles; the chromium (Cr), if present, is in an amount of 4.0 wt. % to 20 wt. %, based on the total weight of the particles; the manganese (Mn), if present, is in an amount of 0.1 wt. % to 15 wt. %, based on the total weight of the particles; the molybdenum (Mo), if present, is in an amount of 1.5 wt. % to 40 wt. %, based on the total weight of the particles; the tungsten (W), if present, is in an amount of 1.0 wt. % to 25 wt. %, based on the total weight of the particles; the bismuth (Bi), if present, is in an amount of 0.5 wt. % to 3.0 wt. %, based on the total weight of the particles; the niobium (Nb) if present, is in an amount of 0.5 wt. % to 5.0 wt. %, based on the total weight of the particles; the tantalum (Ta), if present, is in an amount of 0.5 wt. % to 3.0 wt. %, based on the total weight of the particles; the titanium (Ti), if present, is in an amount of 0.5 wt. % to 3.0 wt. %, based on the total weight of the particles; the vanadium (V), if present, is in an amount of 0.5 wt. % to 8 wt. %, based on the total weight of the particles; the zirconium (Zr), if present, is in an amount of 0.5 wt. % to 3.0 wt. %, based on the total weight of the particles; the hafnium (Hf), if present, is in an amount of 0.5 wt. % to 3.0 wt. %, based on the total weight of the particles; and the total amount of niobium (Nb), tantalum (Ta), titanium (Ti), vanadium (V), zirconium (Zr), and hafnium (Hf) is not greater than 10 wt. %, based on the total weight of the particles.

14. The powder metal material of claim 12, wherein the particles further include at least one of tin (Sn), nickel (Ni), and cobalt (Co); the tin (Sn), if present, is in an amount of 1.0 wt. % to 5.0 wt. %, based on the total weight of the particles; the nickel (Ni), if present, is in an amount of 0.5 wt. % and 20 wt. %, based on the total weight of the particles; and the cobalt (Co), if present, is in an amount of 0.5 wt. % and 25 wt. %, based on the total weight of the particles.

15. The powder metal material of claim 1, wherein the copper (Cu) is present in an amount of 20 wt. % to 40 wt. %, based on the total weight of the particles; the cobalt (Co) is present in an amount of 30 wt. % and 78 wt. %, based on the total weight of the particles; the total amount of iron (Fe), copper (Cu), tin (Sn), nickel (Ni), and cobalt (Co) is at least 50 wt. %, based on the total weight of the particles; and the particles include at least one of boron (B), carbon (C), nitrogen (N), phosphorus (P), sulfur (S), aluminum (Al), silicon (Si), chromium (Cr), manganese (Mn), molybdenum (Mo), tungsten (W), bismuth (Bi), niobium (Nb), tantalum (Ta), titanium (Ti), vanadium (V), zirconium (Zr), and hafnium (Hf); and the total amount of niobium (Nb), tantalum (Ta), titanium (Ti), vanadium (V), zirconium (Zr), and hafnium (Hf) is not greater than 10 wt. %, based on the total weight of the particles.

16. The powder metal material of claim 15, wherein the boron (B), if present, is in an amount of 0.001 wt. % to 0.2 wt. %, based on the total weight of the particles; the carbon (C), if present, is in an amount of 0.5 wt. % to 4.0 wt. %, based on the total weight of the particles; the nitrogen (N), if present, is in an amount of 0.05 wt. % to 0.5 wt. %, based on the total weight of the particles; the phosphorus (P), if present, is in an amount of 1.0 wt. % to 2.0 wt. %, based on the total weight of the particles; the sulfur (S), if present, is in an amount of 0.2 wt. % to 1.2 wt. %, based on the total weight of the particles; the aluminum (Al), if present, is in an amount of 1.0 wt. % to 8.0 wt. %, based on the total weight of the particles; the silicon (Si), if present, is in an amount of is 0.5 wt. % to 5.0 wt. %, based on the total weight of the particles; the chromium (Cr), if present, is in an amount of 10.1 wt. % to 35 wt. %, based on the total weight of the particles; the manganese (Mn), if present, is in an amount of 0.1 wt. % to 15 wt. %, based on the total weight of the particles; the molybdenum (Mo), if present, is in an amount of 5.0 wt. % to 40 wt. %, based on the total weight of the particles; the tungsten (W), if present, is in an amount of 5.0 wt. % to 20 wt. %, based on the total weight of the particles; the bismuth (Bi), if present, is in an amount of 0.5 wt. % to 3.0 wt. %, based on the total weight of the particles; the niobium (Nb) if present, is in an amount of 0.5 wt. % to 5.0 wt. %, based on the total weight of the particles; the tantalum (Ta), if present, is in an amount of 0.5 wt. % to 3.0 wt. %, based on the total weight of the particles; the titanium (Ti), if present, is in an amount of 0.5 wt. % to 3.0 wt. %, based on the total weight of the particles; the vanadium (V), if present, is in an amount of 0.5 wt. % to 8 wt. %, based on the total weight of the particles; the zirconium (Zr), if present, is in an amount of 0.5 wt. % to 3.0 wt. %, based on the total weight of the particles; the hafnium (Hf), if present, is in an amount of 0.5 wt. % to 3.0 wt. %, based on the total weight of the particles; and the total amount of niobium (Nb), tantalum (Ta), titanium (Ti), vanadium (V), zirconium (Zr), and hafnium (Hf) is not greater than 10 wt. %, based on the total weight of the particles.

17. The powder metal material of claim 15, wherein the particles further include at least one of iron (Fe), tin (Sn), and nickel (Ni); the iron (Fe), if present, is in an amount of 0.5 wt. % to 25 wt. %, based on the total weight of the particles; the tin (Sn), if present, is in an amount of 1.0 wt. % to 5.0 wt. %, based on the total weight of the particles; and the nickel (Ni), if present, is in an amount of 0.5 wt. % and 34 wt. %, based on the total weight of the particles.

18. The powder metal material of claim 1, wherein the particles are formed by atomizing an alloy composition, and the copper is prealloyed in the alloy composition before the atomizing.

19. The powder metal material of claim 1, wherein the particles consist of a first area and a second area, the first area being copper-rich and being located in a microstructure and/or along a surface of the particles; and the second area including hard phases, the hard phases being present in an amount of at least 33 wt. %, based on the total weight of the second area.

20. The powder metal material of claim 1, wherein the particles have a microstructure including hard phases, and the hard phases include at least one of FeB, TiB₂, Fe₂N, Fe₃N, TiN, Fe₃C, Cr₂₃C₆, (Cr,Fe)₂₃C₆, MoC, Mo₂C, TiC, Cr₇C₃, ZrC, VNC, TiCN, Fe₂P, Fe₃P, (Ni,Fe)₃P, WSi₂, Nb₅Si₃, (Mo,Co)Si₂, FeMo, CoTi, and NiMo.

21. A component, comprising: a sintered powder metal material, wherein said sintered powder metal material includes copper (Cu) in an amount of 10 wt. % to 50 wt. %, based on the total weight of the sintered powder metal material; said sintered powder metal material includes at least one of iron (Fe), nickel (Ni), cobalt (Co); and said sintered powder metal material includes at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr).

22. The component of claim 21, wherein the component is a valve seat insert, valve guide, or turbo charger bushing.

23. A method of manufacturing a powder metal material, comprising the steps of:
providing a melted alloy composition including copper pre-alloyed in the alloy composition, the copper being present in an amount of 10 wt. % to 50 wt. %, based on the total weight of the composition;
the alloy composition further including at least one of iron (Fe), nickel (Ni), cobalt (Co);
the alloy composition further including at least one of boron (B), carbon (C), chromium (Cr), manganese (Mn), molybdenum (Mo), nitrogen (N), niobium (Nb), phosphorous (P), sulfur (S), aluminum (Al), bismuth (Bi), silicon (Si), tin (Sn), tantalum (Ta), titanium (Ti), vanadium (V), tungsten (W), hafnium (Hf), and zirconium (Zr); and
atomizing the melted alloy composition to atomized particles.

24. The method of claim 23, wherein the atomizing step is water atomizing or gas atomizing, and further including heat treating the atomized particles.
